(19) United States
(12) Patent Application Publication
(10) Pub. No.: US 2003/0196522 A1
(43) Pub. Date: Oct. 23, 2003

(54) Reversible ratchet type wrench

(76) Inventor: Bobby Hu, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/131,105

(22) Filed: Apr. 22, 2002

(51) Int. Cl. B25B 13/46

(52) U.S. Cl. 81/63.2

(57) ABSTRACT

A reversible ratchet type wrench handle comprises a box end extending from an end of the handle and having a hole. A compartment is defined in a peripheral wall defining the hole of the box end and communicated with the hole. A receiving hole extends from a side of the box end toward the other side of the box end but spaced from the other side of the box end. The receiving hole intersects the compartment. A bulge portion is formed in a conjunctive area between the handle and the box end. A slot is defined in the bulge portion and communicated with the compartment.

### BACKGROUND OF THE INVENTION

1. Field of the Invention

The present invention relates to a reversible ratchet type wrench of the type having a bulged portion in a box end thereof, wherein a slot is defined in the bulge portion for installation of a switch member for switching ratcheting directions of the wrench.

2. Description of the Related Art

FIG. 16 of the drawings is an exploded perspective view of a conventional reversible ratchet type wrench comprising a handle 3 and a box end 2 extending from the handle 3. FIG. 17 is a sectional view of the reversible ratchet type wrench. A bulge portion 4 is formed in a conjunctive area between the handle 3 and the box end 2. A gear wheel 1 is rotatably mounted in a hole 7 defined in the box end 2. A compartment 6 is defined in a peripheral wall defining the box end 2 for receiving a pawl 9. A receptacle 94 is defined in a wall defining the compartment 6 and facing the hole 7. A spring 92 and a ball 93 are mounted in the receptacle 94 for biasing the pawl 9 to engage with the gear wheel 1. A slot 5 is defined in the bulge portion 4 and communicated with the compartment 6. A switch member 8 includes a first end with a protrusion 82 for engaging with a notch or groove 91 in an upper side of the pawl 9. The switch member 8 further includes a second end 81 extending outside of the compartment 6 through the slot 5 for manual operation. Thus, the user may switch the second end 81 of the switch member 91 between two positions corresponding to two ratcheting directions of the wrench. However, oil, dirt, ashes, or larger alien objects may enter the compartment 6 through the slot 5 such that the wrench could not be used after the pawl 9 has stuck. Further, the switch member 8 would move together with the pawl 9 during operation of the wrench. The engagement between the pawl 9 and the gear wheel 1 is adversely affected if the second end 81 of the switch member 8 is inadvertently impinged by the user's finger or an alien object. As a result, the torque of the wrench is adversely affected.

### SUMMARY OF THE INVENTION

An object of the present invention is to provide a reversible ratchet type wrench that prevents entrance of alien objects into an interior of the wrench and that provides reliable engagement between the drive member (e.g., a gear wheel) and the pawl.

In accordance with a first aspect of the invention, there is provided a reversible ratchet type wrench comprising:

a handle;

a box end extending from an end of the handle and having a first side and a second side opposite to the first side, a hole being defined in the box end, a compartment being defined in a peripheral wall defining the hole of the box end and communicated with the hole, a receiving hole extending from the first side of the box end toward the second side of the box end but spaced from the second side of the box end, the receiving hole intersecting the compartment;

a bulge portion formed in a conjunctive area between the handle and the box end, a slot being defined in the bulge portion and communicated with the compartment;

a drive member rotatably mounted in the hole of the box end and including a plurality of teeth on an outer periphery thereof;

a pawl slidably mounted in the compartment of the box end and including a toothed side;

a pivotal member rotatably mounted in the receiving hole of the box end;

a switch member extending through the slot of the bulge portion, the switch member including a first end securely engaged with the pivotal member to move therewith and a second end outside the box end for manual operation between two positions corresponding to two ratcheting directions of the wrench;

a pressing member mounted between the pawl and the pivotal member; and

an elastic element for biasing the pressing member against the pawl.

Oil, dirt, ashes, or larger alien objects could not enter the compartment through the slot, as they will be obstructed by the pivotal member in the compartment. Formation of the slot is easy. Further, the switch member would not move together with the pawl during operation of the wrench. The engagement between the pawl and the drive member is not adversely affected.

In accordance with a second aspect of the invention, there is provided a reversible ratchet type wrench handle comprising:

a box end extending from an end of the handle and having a first side and a second side opposite to the first side, a hole being defined in the box end, a compartment being defined in a peripheral wall defining the hole of the box end and communicated with the hole, a receiving hole extending from the first side of the box end toward the second side of the box end but spaced from the second side of the box end, the receiving hole intersecting the compartment; and

a bulge portion formed in a conjunctive area between the handle and the box end, a slot being defined in the bulge portion and communicated with the compartment.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a reversible ratchet type wrench in accordance with the present invention.

FIG. 2 is an exploded perspective view of the reversible ratchet type wrench in FIG. 1.

FIG. 3 is a perspective view, partly cutaway, of the wrench in FIG. 2, illustrating formation of a slot in a bulge portion of a box end of the wrench by a cutter.

FIG. 4 is a perspective view similar to FIG. 3, wherein formation of the slot is completed.

FIG. 5 is a sectional view taken along plane 5-5 in FIG. 1.

FIG. 6 is a sectional view taken along plane 6-6 in FIG. 5.

FIG. 7 is a sectional view taken along plane 7-7 in FIG. 5.

FIG. 8 is a view similar to FIG. 6, wherein a switch member of the wrench is in a position allowing ratcheting in a reverse direction.

FIG. 9 is a view similar to FIG. 6, wherein the switch member of the wrench is in a position allowing ratcheting in a reverse direction.

FIG. 10 is a perspective view illustrating a portion of a second embodiment of the wrench in accordance with the present invention.

FIG. 11 is a schematic top view of the second embodiment of the wrench.

FIG. 12 is a sectional view of the wrench in FIG. 11.

FIG. 13 is perspective view illustrating a portion of a third embodiment of the wrench in accordance with the present invention.

FIG. 14 is a schematic top view illustrating formation of a slot in a bulge portion of the box end of the wrench in FIG. 13.

FIG. 15 is a sectional view illustrating formation of a slot in a bulge portion of the box end of the wrench in FIG. 13.

FIG. 15A is a perspective view illustrating a modified embodiment of the wrench in accordance with the present invention.

FIG. 16 is an exploded perspective view of a conventional reversible ratchet type wrench.

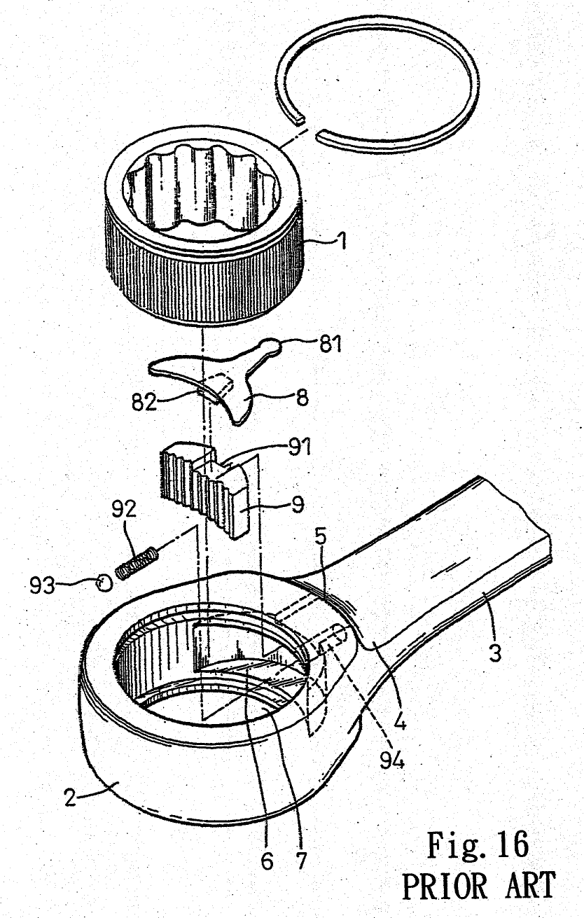

FIG. 17 is a sectional view of the reversible ratchet type wrench in FIG. 16.

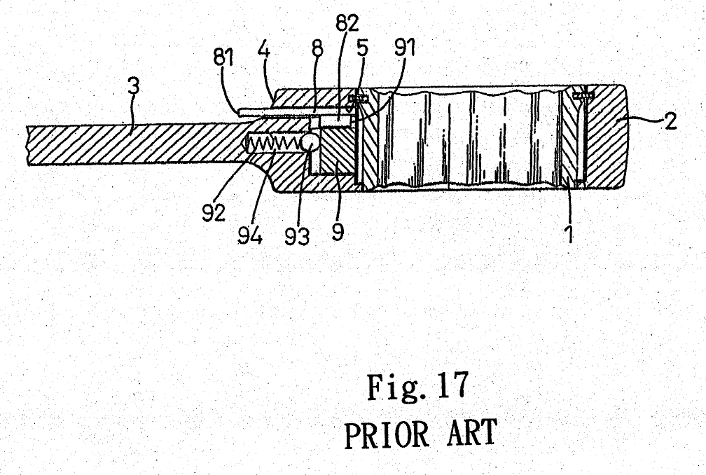

### DETAILED DESCRIPTION OF THE PREFERRED EMBODIMENTS

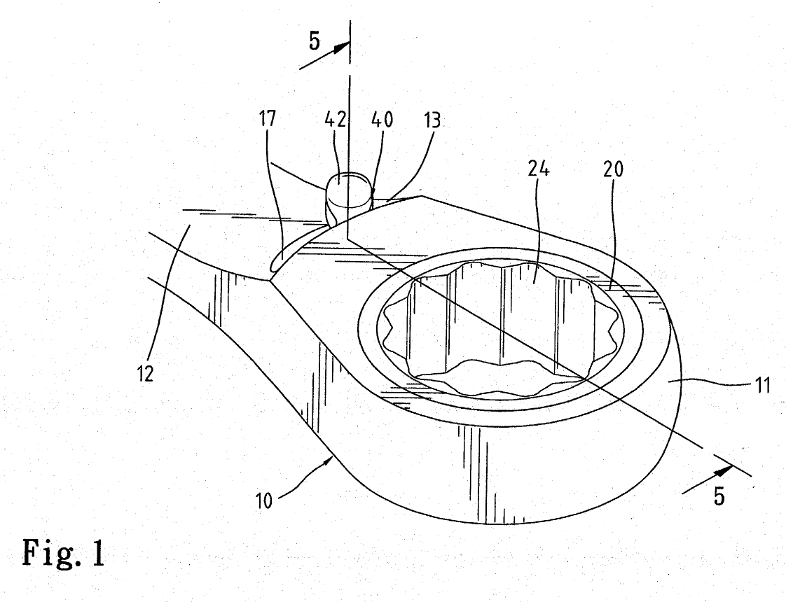

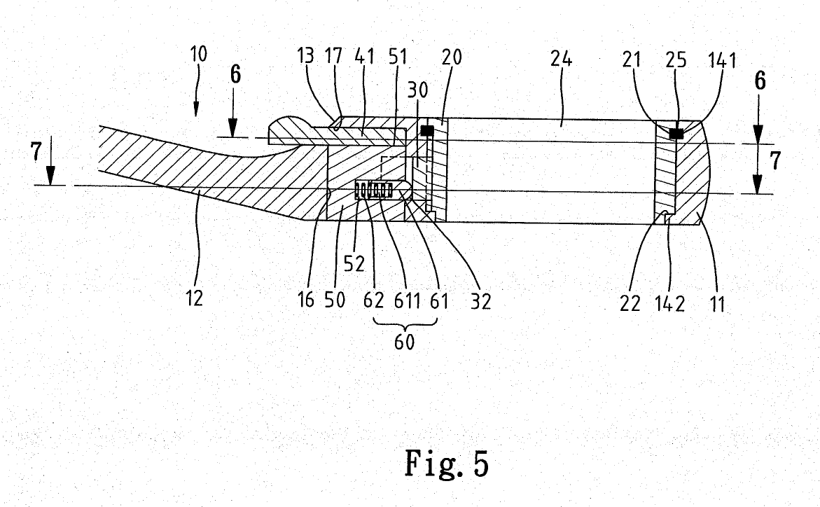

Referring to FIGS. 1, 2, and 5, a first embodiment of a reversible ratchet type wrench in accordance with the present invention is designated by “10” and generally comprises a handle 12 having a box end 11 extending from an end of the handle 12. A bulge portion 13 is formed in a conjunctive area between the handle 12 and the box end 10. An annular groove 141 is defined in an end of a peripheral wall defining a hole 14 in the box end 11, and an annular ledge 142 is formed on the other end of the peripheral wall defining the hole 14 of the box end 11.

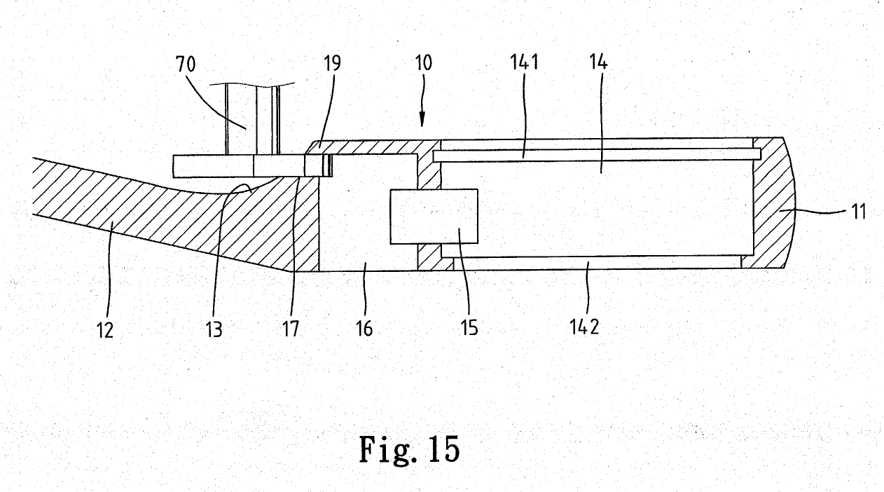

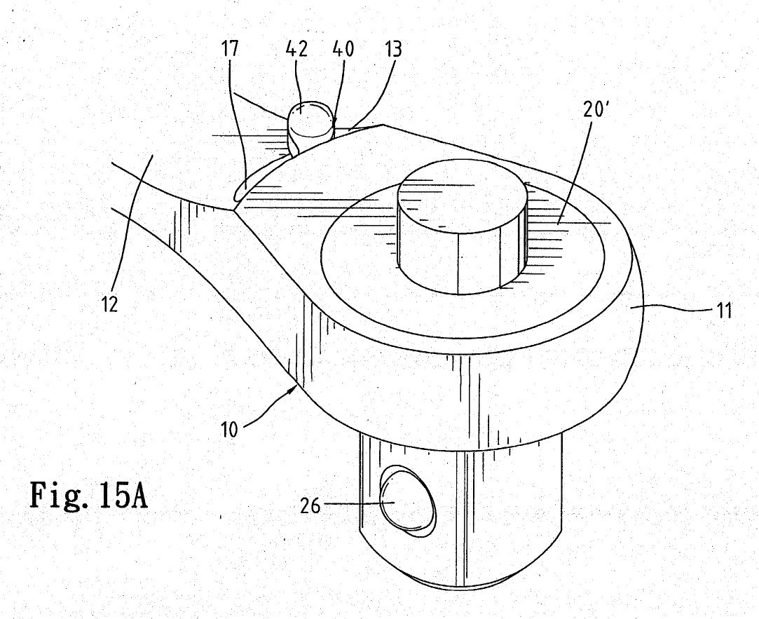

A drive member (e.g., a gear wheel) 20 is rotatably mounted in the hole 14 of the box end 11 and includes an inner periphery 24 for driving a fastener. The gear wheel 20 further includes an outer periphery having a first end with an annular groove 21, a second end with a recessed portion 22, and an intermediate portion with a plurality of teeth 23. The gear wheel 20 is received in the hole 14 of the box end 11 with a C-clip 25 partially engaged in the annular groove 141 of the box end 11 and partially engaged in the annular groove 21 of the gear wheel 20 and with the recessed portion 22 of the second end of the gear wheel 20 abutting on the annular ledge 142 of the box end 11. Thus, the annular ledge 142 of the box end 11 prevents disengagement of the gear wheel 20. In an alternative embodiment, as shown in FIG. 15, the drive member (now designated by 20′) includes a drive column 26 instead of the inner periphery in the first embodiment. Thus, the wrench can be used with a socket (not shown).

A compartment 15 is defined in a peripheral wall defining the hole 14 of the box end 11 and communicated with the hole 14. A receiving hole 16 extends from a side of the box end 11 toward the other side of the box end 11 but spaced from the other side of the box end 11. The receiving hole 16 intersects with the compartment 15. Preferably, the receiving hole 16 extends in a direction perpendicular to a general plane of the compartment 15. A slot 17 is defined in the bulge portion 13 and communicated with the receiving hole 16.

A pawl 30 is slidably mounted in the compartment 15 of the box end 11 and includes a toothed first side 31 and a second side opposite to the first side 31. The second side of the pawl 30 includes a retaining groove 32 with two sides. Further, the pawl 30 includes a first abutting end 33 and a second abutting end 33 for abutting against a wall defining the compartment 15 that receives the pawl 30.

A pivotal member 50 is rotatably mounted in the receiving hole 16 and includes an end with an engaging groove 51. Further, the pivotal member 50 includes a receptacle 52 in a periphery thereof for receiving a biasing means 60 comprised of an elastic element (e.g., a spring 62) and a pressing member (e.g., a pin 61) having a blind hole 611 for receiving a portion of the spring 62. Further, the pivotal member 50 includes two grooves 53 and 54 in the periphery and located on both sides of the receptacle 52.

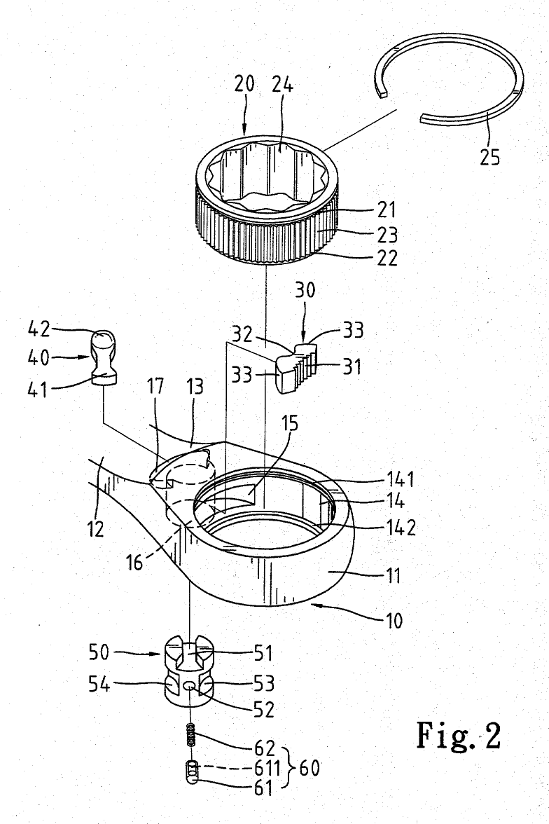

A switch member 40 includes a first end 42 engaged in the engaging groove 51 of the pivotal member 50 and a second end 41 outside the box end 11 of the wrench 10. It is appreciated that the switch member 40 extends through the slot 17 of the bulge portion 13 of the wrench 10, and the slot 17 is sufficiently long to allow pivotal movement of the switch member 40. As illustrated in FIG. 2, the engaging groove 51 is preferably I-shaped for securely receiving the first end 42 of the switch member 40 having a corresponding configuration. The second end 42 of the switch member 40 is wide enough to avoid painful feeling in the user's finger during switching.

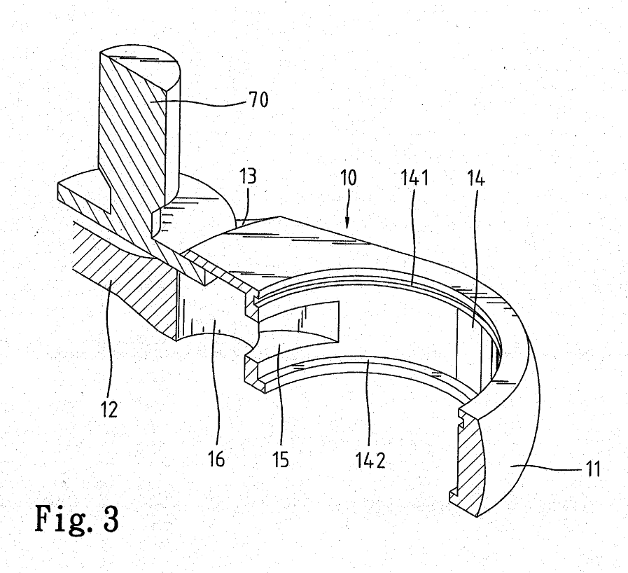

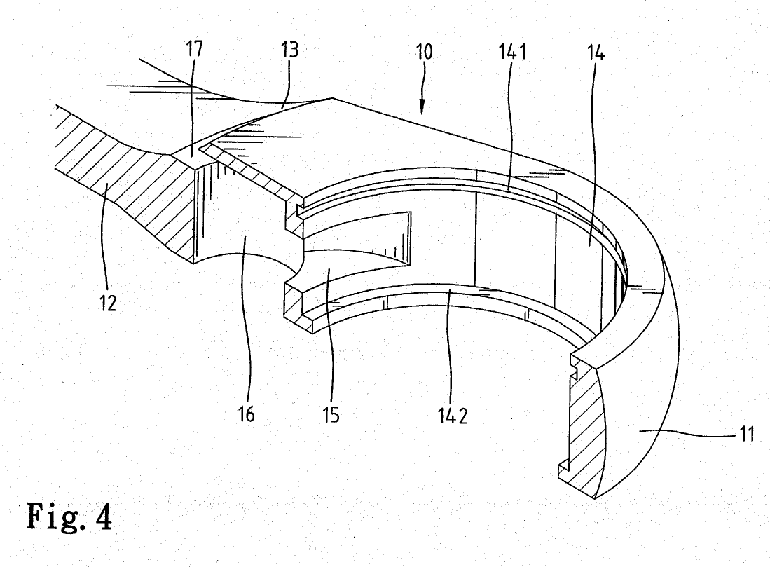

FIG. 3 illustrates formation of the slot 17 in the bulge portion 13 of the box end 11 by means of milling by a cutter 0.70. As illustrated in FIG. 4, after formation, the slot 17 is communicated with an end of the receiving hole 16.

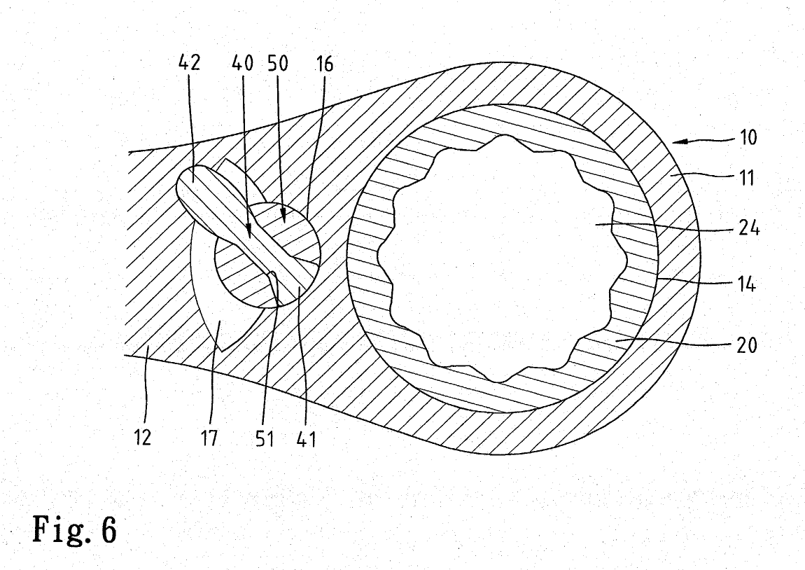

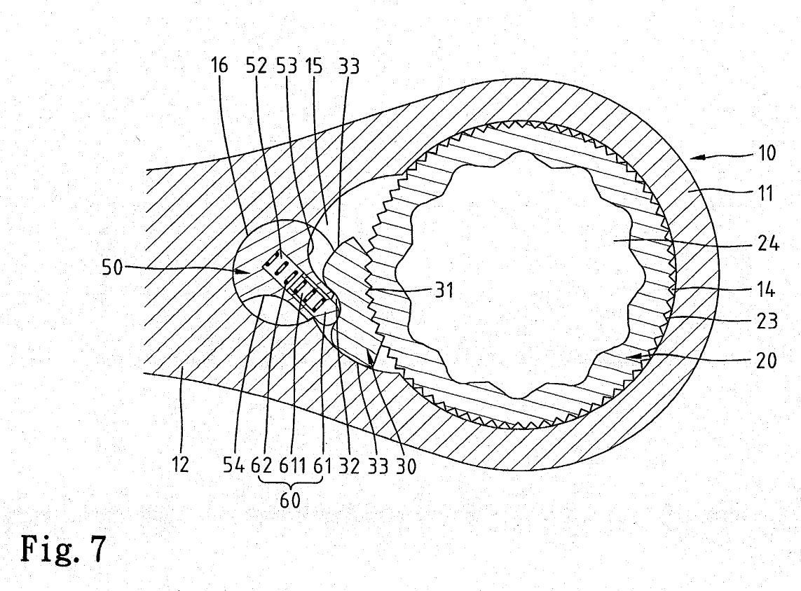

When the switch member 40 is in a position shown in FIGS. 6 and 7, the pin 61 is biased by the spring 62 to press against a side of the retaining groove 32, which, in turn, biases the pawl 30 to engage with the teeth 23 of the gear wheel 20 with an abutting end 33 of the pawl 30 pressing against a portion of the wall defining the compartment 15. Thus, the wrench allows ratcheting in the counterclockwise direction and allows free rotation in the clockwise direction. It is noted that a portion of the pawl 30 is received in the receiving groove 53 of the pivotal member 50, thereby preventing disengagement of the pivotal member 50 from the receiving hole 16.

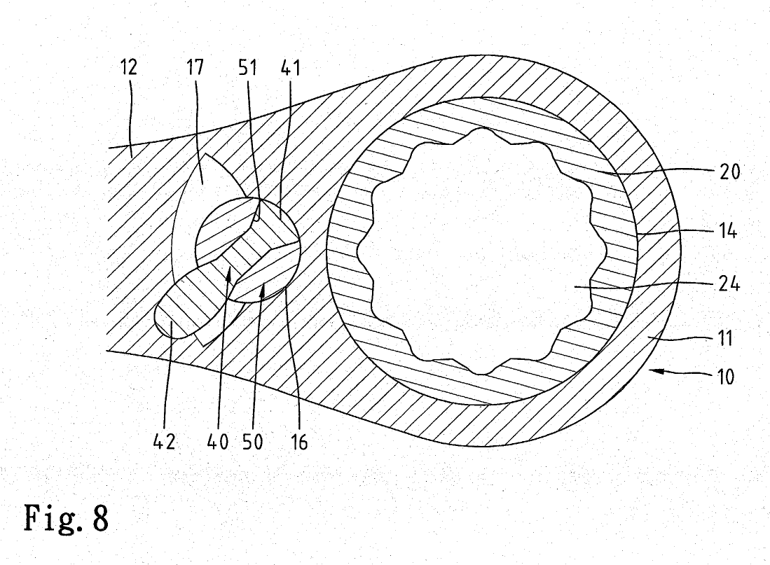

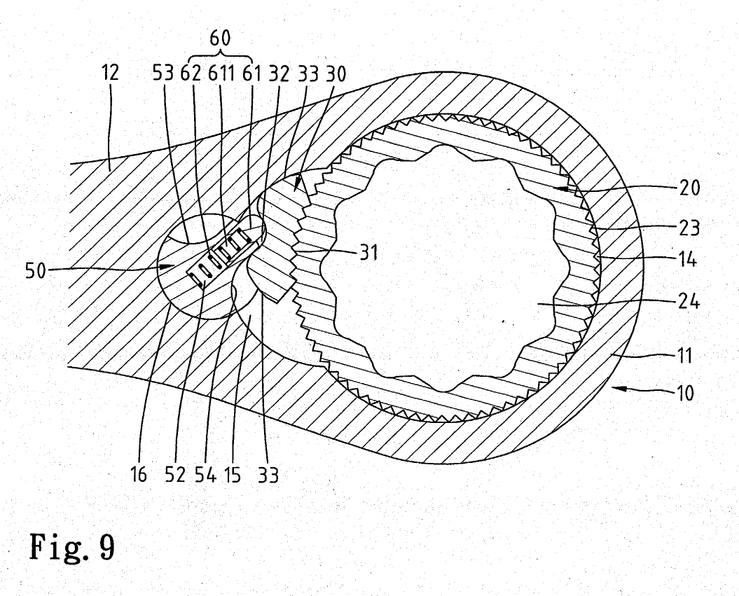

When the switch member 40 is in a position shown in FIGS. 8 and 9, the pin 61 is biased by the spring 62 to press against the other side of the retaining groove 32, which, in turn, biases the pawl 30 to engage with the teeth 23 of the gear wheel 20 with the other abutting end 33 of the pawl 30 pressing against another portion of the wall defining the compartment 15. Thus, the wrench allows ratcheting in the clockwise direction and allows free rotation in the counterclockwise direction. It is noted that a portion of the pawl 30 is received in the other receiving groove 54 of the pivotal member 50, thereby preventing disengagement of the pivotal member 50 from the receiving hole 16.

In either position, alien objects, oil, or dirt are not allowed to enter the compartment 15 that receives the pawl 30, as they will be obstructed by the pivotal member 50 in the receiving hole 16. Further, the switch member 40 would not move together with the pawl 30 during operation of the wrench. The engagement between the pawl 30 and the gear wheel 20 is not adversely affected.

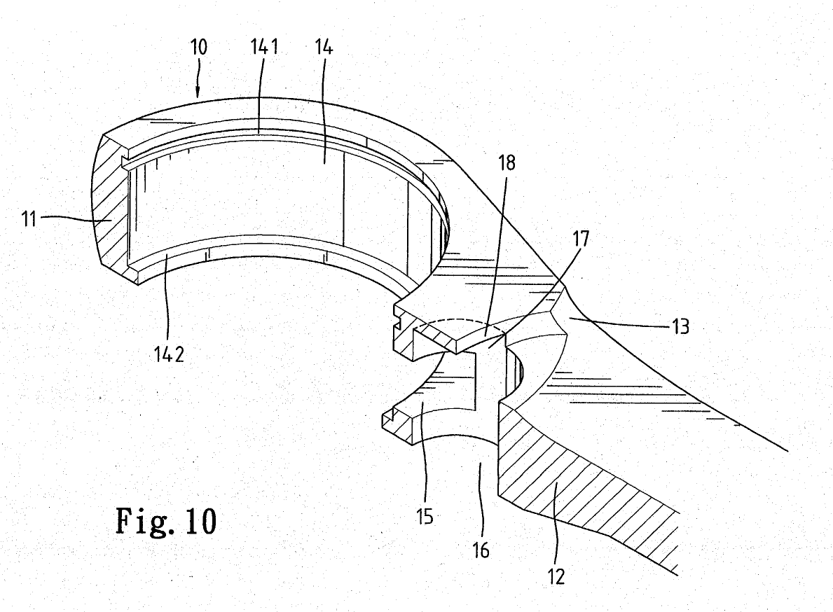

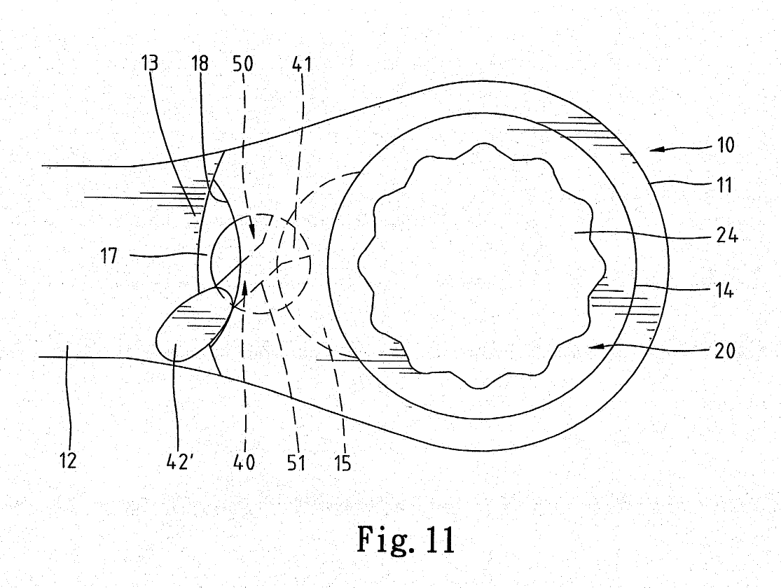

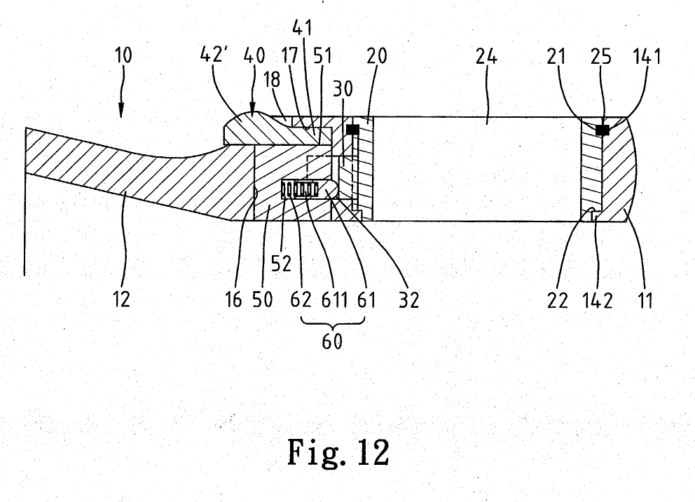

FIGS. 10 through 12 illustrate a second embodiment of the invention, wherein the bulge portion 13 of the box end 11 includes an arcuate portion 18 such that a portion of the slot 17 is exposed, best shown in FIG. 11. Thus, the switch member 40 may have a shorter length, and the second end (now designated by 42′) of the switch member 40 may be wider to further avoid painful feeling in the user's finger during switching.

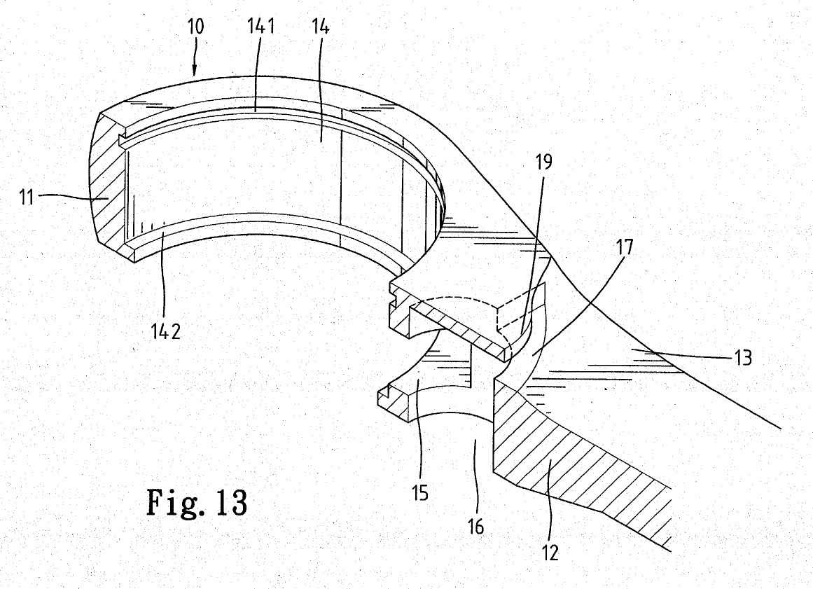

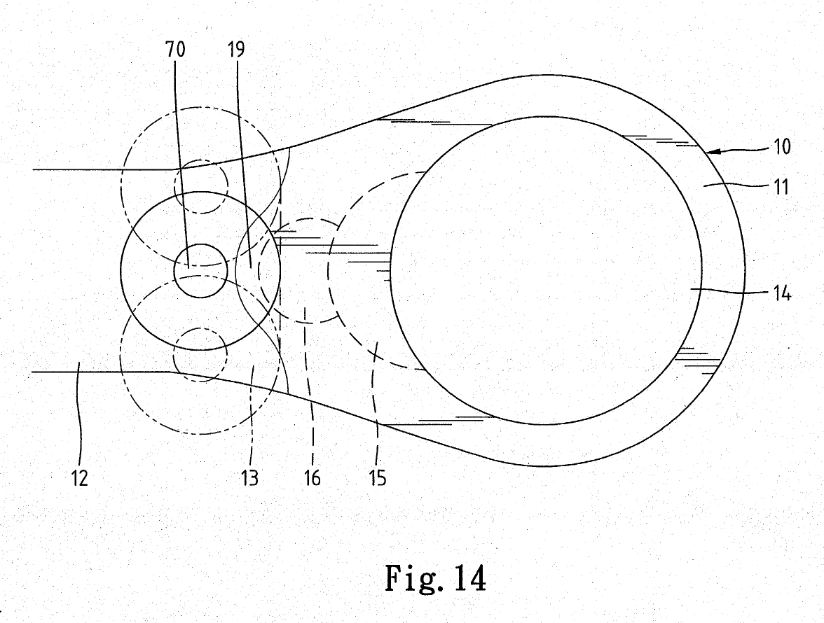

FIGS. 13 through 15 illustrate a third embodiment of the invention, wherein the bulge portion 13 includes an end edge 19 extending away from the receiving hole 16 to a position beyond a peripheral wall defining the receiving hole 16, best shown in FIG. 15. FIGS. 14 and 15 illustrate formation of the slot 17 by means of milling by a cutter 70 that moves along a direction perpendicular to a longitudinal axis of the handle 12. Preferably, the end edge 19 is curved, best shown in FIG. 14. The end edge 19 may shield most part of the switch member 40 except the second end 42 of the switch member 40. Thus, the risk of inadvertent impingement to the switch member 40 is lowered.

According to the above description, it is noted that oil, dirt, ashes, or larger alien objects could not enter the compartment 15 through the slot 17. Formation of the slot 17 is easy. Further, the switch member 40 would not move together with the pawl 30 during operation of the wrench. The engagement between the pawl 30 and the gear wheel 20 is not adversely affected.

Although the invention has been explained in relation to its preferred embodiment, it is to be understood that many other possible modifications and variations can be made without departing from the scope of the invention as hereinafter claimed.

What is claimed is:

1. A reversible ratchet type wrench comprising:
a handle;
a box end extending from an end of the handle and having a first side and a second side opposite to the first side, a hole being defined in the box end, a compartment being defined in a peripheral wall defining the hole of the box end and communicated with the hole, a receiving hole extending from the first side of the box end toward the second side of the box end but spaced from the second side of the box end, the receiving hole intersecting the compartment;
a bulge portion formed in a conjunctive area between the handle and the box end, a slot being defined in the bulge portion and communicated with the compartment;
a drive member rotatably mounted in the hole of the box end and including a plurality of teeth on an outer periphery thereof;
a pawl slidably mounted in the compartment of the box end and including a toothed side;
a pivotal member rotatably mounted in the receiving hole of the box end;
a switch member extending through the slot of the bulge portion, the switch member including a first end securely engaged with the pivotal member to move therewith and a second end outside the box end for manual operation between two positions corresponding to two ratcheting directions of the wrench;
a pressing member mounted between the pawl and the pivotal member; and
an elastic element for biasing the pressing member against the pawl.

2. The reversible ratchet type wrench as claimed in claim 1, wherein the outer periphery of the drive member includes an end with an annular groove, the peripheral wall defining the hole of the box end including an annular groove in an end thereof, further including a C-clip partially received in the annular groove of the drive member and partially received in the annular groove of the peripheral wall defining the hole of the box end.

3. The reversible ratchet type wrench as claimed in claim 1, wherein the wherein the outer periphery of the drive member includes an end with a recessed portion, the peripheral wall defining the hole of the box end including an annular ledge on an end thereof, the recessed portion of the drive member abutting on the annular ledge of the box end, thereby preventing disengagement of the drive member.

4. The reversible ratchet type wrench as claimed in claim 2, wherein the wherein the outer periphery of the drive member includes another end with a recessed portion, the peripheral wall defining the hole of the box end including an annular ledge on another end thereof, the recessed portion of the drive member abutting on the annular ledge of the box end, thereby preventing disengagement of the drive member.

5. The reversible ratchet type wrench as claimed in claim 1, wherein the slot of the bulge portion is communicated with an end of the compartment of the box end.

6. The reversible ratchet type wrench as claimed in claim 1, wherein the pivotal member includes an engaging groove on an end thereof for securely receiving the first end of the switch member.

7. The reversible ratchet type wrench as claimed in claim 6, wherein the engaging groove of the pivotal member is substantially I-shaped.

8. The reversible ratchet type wrench as claimed in claim 1, wherein the pivotal member includes a receptacle in an outer periphery thereof for receiving the elastic element and the pressing member.

9. The reversible ratchet type wrench as claimed in claim 6, wherein the pivotal member includes a receptacle in an outer periphery thereof for receiving the elastic element and the pressing member.

10. The reversible ratchet type wrench as claimed in claim 8, wherein the pressing member includes a blind hole in an end thereof for receiving an end of the elastic element.

11. The reversible ratchet type wrench as claimed in claim 8, wherein the pivotal member further includes two grooves located on both sides of the receptacle, a portion of the pawl being selectively received in one of the grooves, thereby preventing disengagement of the pivotal member from the receiving hole.

12. The reversible ratchet type wrench as claimed in claim 9, wherein the pressing member includes a blind hole in an end thereof for receiving an end of the elastic element.

13. The reversible ratchet type wrench as claimed in claim 1, wherein the pawl includes a second side opposite to the toothed side, a retaining groove being defined in the second side of the pawl and including two sides, the pressing member being biased by the elastic element to selectively press against one of the sides of the retaining groove.

14. The reversible ratchet type wrench as claimed in claim 13, wherein the pawl further includes two abutting ends for selectively abutting against a wall defining the compartment.

15. The reversible ratchet type wrench as claimed in claim 1, wherein the bulge portion includes an arcuate portion, leaving a portion of the slot exposed.

16. The reversible ratchet type wrench as claimed in claim 1, wherein the bulge portion including an end edge extending away from the receiving hole to a position beyond a peripheral wall defining the receiving hole.

17. A reversible ratchet type wrench handle comprising:
a box end extending from an end of the handle and having a first side and a second side opposite to the first side, a hole being defined in the box end, a compartment being defined in a peripheral wall defining the hole of the box end and communicated with the hole, a receiving hole extending from the first side of the box end toward the second side of the box end but spaced from the second side of the box end, the receiving hole intersecting the compartment; and
a bulge portion formed in a conjunctive area between the handle and the box end, a slot being defined in the bulge portion and communicated with the compartment.

18. The reversible ratchet type wrench as claimed in claim 17, wherein the slot of the bulge portion is communicated with an end of the compartment of the box end.

19. The reversible ratchet type wrench as claimed in claim 17, wherein the bulge portion includes an arcuate portion, leaving a portion of the slot exposed.

20. The reversible ratchet type wrench as claimed in claim 17, wherein the bulge portion including an end edge extending away from the receiving hole to a position beyond a peripheral wall defining the receiving hole.
